(19) United States
(12) Patent Application Publication
(10) Pub. No.: US 2025/0332652 A1
(43) Pub. Date: Oct. 30, 2025

(54) SPOT WELDING METHOD

(71) Applicant: HONDA MOTOR CO., LTD., Tokyo (JP)

(72) Inventors: Hitoshi SAITO, Tokyo (JP); Xihao TAN, Tokyo (JP); Shinya WATANABE, Tokyo (JP)

(21) Appl. No.: 19/096,759

(22) Filed: Apr. 1, 2025

(30) Foreign Application Priority Data
Apr. 24, 2024 (CN) 202410498852.1

(51) Int. Cl. B23K 11/24; B23K 11/00; B23K 11/11; B23K 101/18

(52) U.S. Cl. CPC B23K 11/241; B23K 11/0026; B23K 11/115; B23K 2101/18

(57) ABSTRACT

Provided is a spot welding method capable of performing current control that makes a rising slope of waveform constant even in a case where pulse-shaped waveforms overlap with each other. The spot welding method includes, for a welding current L10: setting a target rise current value P for each predetermined PWM pulse when the welding current L10 increases toward a peak current range R1; and setting, as a first target current value A, a target rise current value P that is larger than and the closest to a rise start current value S in a case where an effective value L14 of the welding current reaches a set welding current L23 while the welding current is decreasing toward a bottom current PB.

### CROSS REFERENCE TO RELATED APPLICATIONS

This application claims the benefit of priority to Chinese Patent Application No. CN202410498852.1 filed on Apr. 24, 2024. The entire contents of this application are hereby incorporated herein by reference.

### BACKGROUND OF THE INVENTION

### Field of the Invention

The present invention relates to a spot welding method.

### Related Art

There are cases where spot welding using a spot welding apparatus is performed to weld metal plates to each other. In spot welding, electric power is applied between a pair of electrode tips in a state in which a plurality of metal plates are held between the pair of electrode tips to thereby generate a nugget between the plurality of metal plates, so that the plurality of metal plates are welded.

In the invention disclosed in PCT International Publication No. WO2020/050011, a plurality of micropulses are applied to a plurality of metal plates held between a pair of electrodes, whereby the plurality of metal plates are welded.
Patent Document 1: PCT International Publication No. WO2020/050011

### SUMMARY OF THE INVENTION

The invention disclosed in PCT International Publication No. WO2020/050011 provides a spot welding method which makes it possible to reliably join a workpiece while reducing occurrence of spatter. In the spot welding method, a welding current having a predetermined pulse-shaped waveform is used. The pulse-shaped waveform includes a peak state in which the welding current has a predetermined value, and a non-peak state that is a state other than the peak state. In a case where an effective value of the welding current reaches a value within a predetermined target range in the non-peak state, current control of increasing the welding current to achieve the peak state is started. In this way, the current control is started at such timing that occurrence of spatter is reduced while energy allowing the welding current to form a nugget of a proper size is supplied to the workpiece. An increase in the welding current toward the peak state is controlled by a rise time set in advance, in other words, a time period taken until the welding current reaches a peak current.

Incidentally, in the invention disclosed in PCT International Publication No. WO2020/050011, when the effective value of the welding current increases to a high level, a waveform rises while a preceding waveform is falling in the non-peak state, which may cause overlap of the pulse-shaped waveforms. In the invention disclosed in PCT International Publication No. WO2020/050011, the welding current is controlled by a rise time period set in advance. Therefore, in a case where the overlap of the pulse-shaped waveforms is caused, a first wave and a second wave may have waveforms with different rising slopes. If the rising slope of waveform changes, conditions for heat input to a welding spot are not constant, which leads to degradation of welding quality.

An object of the present invention is to provide a spot welding method capable of performing current control that makes a rising slope of waveform constant even in a case where pulse-shaped waveforms overlap with each other.

(1) A spot welding method according to the present invention is spot welding method in which a welding current is controlled by PWM control, the welding current having a pulse-shaped waveform that alternates between a peak state in which the welding current reaches or is maintained within a set peak current range and a non-peak state in which the welding current increases toward the peak current range again after having decreased from the peak current range toward a bottom current. The spot welding method includes: starting, in the non-peak state, current control of increasing the welding current toward the peak current range to thereby join a workpiece in a case where an effective value of the welding current reaches a value within a set target range; setting a target rise current value for each predetermined PWM pulse when the welding current increases toward the peak current range; and setting, as a first target current value, the target rise current value that is larger than and the closest to a rise start current value in a case where the effective value of the welding current reaches a value within the set target range while the welding current is decreasing toward the bottom current.

According to the above-described method, when the effective value of the welding current reaches a value within the set target range while the welding current is decreasing toward the bottom current, the target rise current value that is larger than and the closest to a rise start current value is set as a first target current value. This makes it possible to maintain a constant rising slope of the welding current even in a case where the welding current is increased toward the peak current range while the welding current is decreasing toward the bottom current, which stabilizes a heat input quantity. Therefore, the degradation in welding quality can be reduced.

(2) The above-described spot welding method further includes, for the target rise current value: setting a target value next largest to the first target current value as a second target current value; and setting an intermediate target current value between the first target current value and the second target current value.

According to the above-described method, in a case where a next pulse-shaped waveform rises while the pulse-shaped waveform is falling, that is, in a case where the pulse-shaped waveforms overlap, a fluctuation in pulse width immediately after the rising increases, causing sharp rising, which may cause bias magnetism of a welding transformer. The intermediate target current value is set between the first target current value and the second target current value, so that a sudden fluctuation in pulse width can be reduced.

(3) The above-described spot welding method further includes controlling the effective value of the welding current such that the target rise current value that is lower than a rise start current value at the starting the current control of increasing the welding current is not included in an arithmetic operation.

According to the above-described method, the target rise current value that is lower than the rise start current value is removed, so that a control load can be reduced.

(4) In the above-described spot welding method, the intermediate target current value is calculated by the following calculation equation:

$${A}^{′} = A + coefficient \times ( B - A ) ;$$

where A is the first target current value, A′ is the intermediate target current value, B is the second target current value, and
the coefficient is any value of 0% or more and 100% or less.

According to the above-described method, the value of the coefficient is adjusted by the above-described calculation equation, so that the intermediate target value can be set so as to allow more stable rising.

The present invention can provide a spot welding method capable of performing current control that makes a rising slope of waveform constant even in a case where pulse-shaped waveforms overlap with each other.

### BRIEF DESCRIPTION OF THE DRAWINGS

FIG. 1 is a diagram illustrating a configuration of a welding system to which a spot welding method of one embodiment of the present invention is applied;

FIG. 2 is a diagram illustrating a circuit configuration of a welding power source circuit;

FIG. 3 is a graph showing a relationship between an AC voltage input from an inverter circuit to a transformer and a welding current applied to a pair of electrode tips in the welding power source circuit;

FIG. 4 is a diagram schematically illustrating a cross-section of a workpiece during welding;

FIG. 5 is a flowchart illustrating a procedure of welding current control in a control device;

FIG. 6 is a graph showing a waveform of the welding current achieved by the welding current control of FIG. 5;

FIG. 7 is a graph showing a relationship between a difference in set welding current and a waveform of the welding current;

FIG. 8 is a graph showing a waveform of the welding current of the present embodiment;

FIG. 9 is a graph showing a frame R50 of FIG. 8 in an enlarged manner;

FIG. 10 is an enlarged graph showing an intermediate target current value in the frame R50 of FIG. 8;

FIG. 11 is a flowchart illustrating a process flow of the spot welding method of the present embodiment;

FIG. 12 is a graph showing the welding current in a case where the intermediate target current is not set; and

FIG. 13 is a graph showing the welding current in a case where the intermediate target current is set.

### DETAILED DESCRIPTION OF THE INVENTION

### First Embodiment

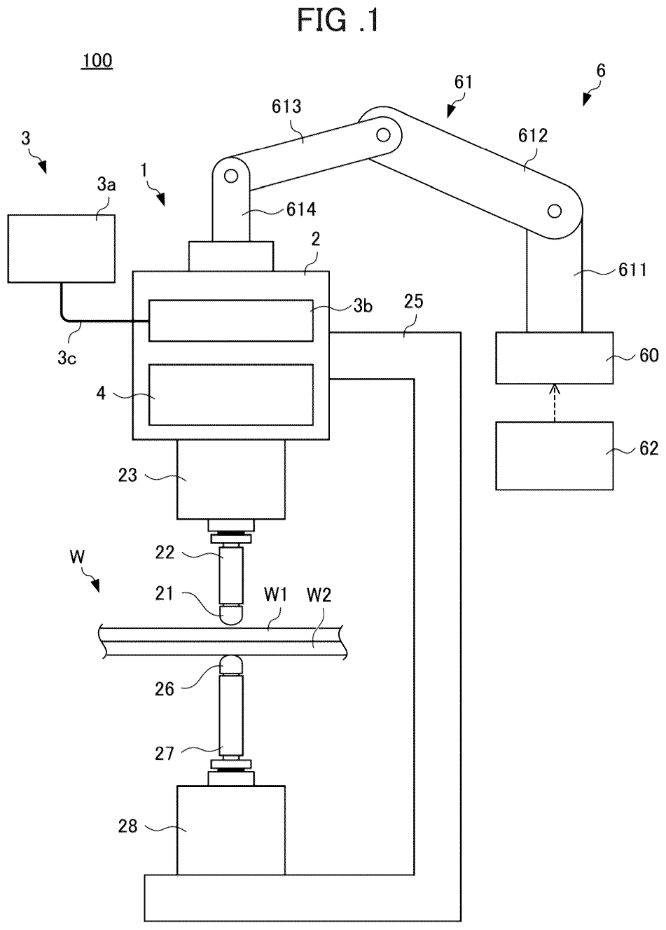

A spot welding method of one embodiment of the present invention will be described with reference to the drawings. FIG. 1 is a diagram illustrating a configuration of a welding system 100 to which a spot welding method of the present embodiment is applied.

### (Welding System)

The welding system 100 includes a spot welding apparatus 1 serving as a welding gun, a workpiece W serving as a multilayer body of metal plates joined to each other by the spot welding apparatus 1, and a robot 6 that supports the spot welding apparatus 1.

The workpiece W is a multilayer body configured such that a plurality of metal plates are stacked on each other. In the present embodiment, a case where a first metal plate W1 and a second metal plate W2 that are two metal plates are stacked on each other in this order from the top to the bottom to form a multilayer body as the workpiece W will be described, but the present invention is not limited to such a case. The number of metal plates forming the workpiece W may be three or more. The thicknesses of the metal plates to be stacked may be the same or different from each other.

The robot 6 includes a robot body 60 attached to a floor surface, an articulated arm 61 pivotally supported on the robot body 60, and a robot control device 62 that controls the robot 6. The articulated arm 61 includes a first arm portion 611 whose proximal end side is pivotally supported on the robot body 60, a second arm portion 612 whose proximal end side is pivotally supported on the first arm portion 611, a third arm portion 613 whose proximal end side is pivotally supported on the second arm portion 612, and a fourth arm portion 614 whose proximal end side is pivotally supported on the third arm portion 613 and whose distal end side is attached to the spot welding apparatus 1.

The robot control device 62 drives a plurality of motors provided in the robot body 60 and the articulated arm 61 to drive each of the arm portions 611 to 614, thereby controlling the position and orientation of the spot welding apparatus 1 attached to the fourth arm portion 614 and moving an upper electrode tip 21 and a lower electrode tip 26 (which will be described later) provided in the spot welding apparatus 1 to a joint portion of the workpiece W.

The spot welding apparatus 1 includes a welding power source circuit 3 serving as a welding current supply source, a gun body 2 on which an upper electrode tip movement mechanism 4 (which will be described later) and part of the welding power source circuit 3 are mounted, the upper electrode tip 21 and the lower electrode tip 26 serving as a pair of electrodes, an upper electrode tip support portion 22, an upper adaptor body 23, a gun arm 25, a lower electrode tip support portion 27, and a lower adaptor body 28.

The upper electrode tip support portion 22 is formed in the shape of a rod extending along a vertical direction, and the upper electrode tip 21 is attached to a distal end portion of the upper electrode tip support portion 22. The upper adaptor body 23 is formed in a column shape, and connects the gun body 2 and the upper electrode tip support portion 22 to each other. The upper adaptor body 23 is, relative to the gun body 2, provided slidably along a direction parallel with the axis of the upper electrode tip support portion 22.

The gun arm 25 extends to curve from the gun body 2 to below the upper electrode tip 21 in the vertical direction. The lower electrode tip support portion 27 is formed in the shape of a rod coaxial with the upper electrode tip support portion 22, and the lower electrode tip 26 is attached to a distal end portion of the lower electrode tip support portion 27. The lower adaptor body 28 is formed in a column shape, and connects a distal end portion of the gun arm 25 and the lower electrode tip support portion 27 to each other. As illustrated in FIG. 1, the lower electrode tip 26 is supported on the lower electrode tip support portion 27 to face the upper electrode tip 21 with a predetermined interval along the axes of the upper electrode tip support portion 22 and the lower electrode tip support portion 27.

The upper electrode tip movement mechanism 4 includes a cylinder, a control device therefor, and the like, and together with the upper electrode tip support portion 22 and the upper electrode tip 21, moves the upper adaptor body 23 back and forth along the direction parallel with the axis of the upper electrode tip support portion 22. This enables the upper electrode tip 21 to contact an upper surface of the workpiece W with the lower electrode tip 26 contacting a lower surface of the workpiece W, and further enables the workpiece W to be held between and pressurized by these upper electrode tip 21 and lower electrode tip 26.

### (Welding Power Source Circuit)

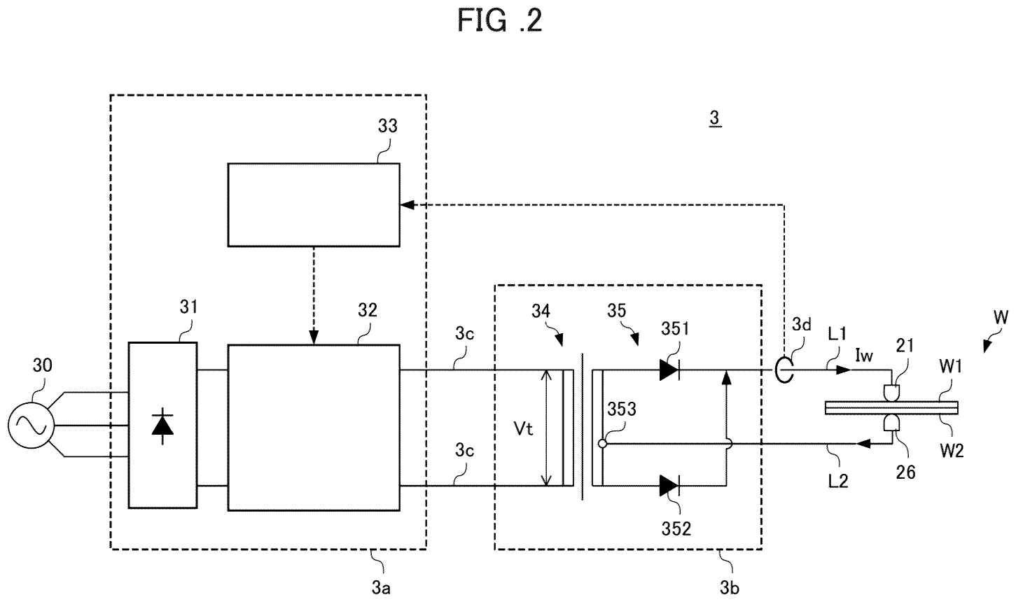

FIG. 2 is a diagram illustrating a circuit configuration of the welding power source circuit 3. The welding power source circuit 3 includes a welding control circuit 3a, a DC welding transformer 3b, power cables 3c, and a current sensor 3d. The welding power source circuit 3 is connected to the upper electrode tip 21 and the lower electrode tip 26 through a first power line L1 and a second power line L2. As illustrated in FIG. 1, the DC welding transformer 3b and the current sensor 3d in the welding power source circuit 3 configured as described above are mounted on the gun body 2. Furthermore, the welding control circuit 3a in the welding power source circuit 3 is mounted on a base separated from the gun body 2, and is connected to the DC welding transformer 3b through the power cables 3c. This makes it possible to reduce the weight of the gun body 2.

The welding control circuit 3a includes a converter circuit 31, an inverter circuit 32, and a control device 33. Furthermore, the DC welding transformer 3b includes a transformer 34, and a rectification circuit 35.

The converter circuit 31 performs full-wave rectification for a three-phase power input from a three-phase power source 30, thereby converting the three-phase power into a DC power and supplying the DC power to the inverter circuit 32.

The inverter circuit 32 converts the DC power input from the converter circuit 31 into a single-phase AC power, thereby outputting the single-phase AC power to the transformer 34 through the power cables 3c. Specifically, the inverter circuit 32 includes four bridge-connected switching elements. The inverter circuit 32 turns on or off these switching elements according to a gate drive signal transmitted from a gate drive circuit mounted on the control device 33, thereby converting the DC power into the single-phase AC power.

The transformer 34 transforms the AC power input from the inverter circuit 32, thereby outputting the transformed AC power to the rectification circuit 35. The rectification circuit 35 rectifies the AC power input from the transformer 34, and outputs a DC power to between the upper electrode tip 21 connected to the first power line L1 and the lower electrode tip 26 connected to the second power line L2. For example, a known full-wave rectification circuit including a first rectification diode 351 and a second rectification diode 352 in combination with a center tap 353 is used for the rectification circuit 35.

The current sensor 3d detects a welding current supplied from the welding power source circuit 3 to the upper electrode tip 21 and the lower electrode tip 26. The current sensor 3d is, for example, provided on the first power line L1 connecting the rectification circuit 35 and the upper electrode tip 21 to each other, and transmits, to the control device 33, a current detection signal according to the level of the welding current flowing through the first power line L1.

The control device 33 includes a microcomputer that executes welding current control (which will be described later) by means of the current detection signal transmitted from the current sensor 3d, the gate drive circuit that generates a gate drive signal according to an arithmetic operation result of the microcomputer and transmits the gate drive signal to the inverter circuit 32, and the like.

### (AC Voltage Vt and Welding Current Iw)

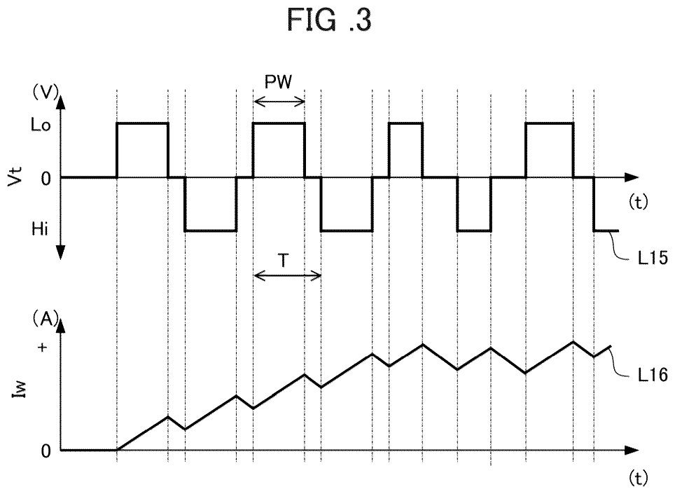

FIG. 3 is a graph showing a relationship between an AC voltage Vt input from the inverter circuit 32 to the transformer 34 and a welding current Iw applied to the upper electrode tip 21 and the lower electrode tip 26 in the welding power source circuit 3 as described above. In FIG. 3, the horizontal axis of the graph indicates the time (t). In FIG. 3, a line L15 indicates the AC voltage Vt input to the transformer 34, and a line L16 indicates the welding current Iw applied to the upper electrode tip 21 and the lower electrode tip 26. In FIG. 3, the vertical axis with respect to the line L15 indicates the voltage (V), and the vertical axis with respect to the line L16 indicates the current (A).

When the inverter circuit 32 is driven, the AC voltage Vt in the shape of a rectangular wave as shown in FIG. 3 is output from the inverter circuit 32. The AC voltage output from the inverter circuit 32 is transformed in the transformer 34, and is further rectified in the rectification circuit 35, and then the DC welding current Iw is applied to the workpiece W through the upper electrode tip 21 and the lower electrode tip 26.

As shown in FIG. 3, the welding current Iw increases as a duty cycle increases. The duty cycle is the ratio of a pulse width PW, which is the period in which the AC voltage Vt is Hi or Lo, to a predetermined carrier cycle T. The control device 33 determines the pulse width PW according to a known feedback control rule such as PI control such that the output current of the welding power source circuit 3 detected by the current sensor 3d reaches a target current set by a process (not illustrated), and performs ON/OFF drive of the plurality of switching elements in the inverter circuit 32 by PWM control with the duty cycle determined by the pulse width PW.

### (Procedure of Spot Welding Method)

Next, the procedure of the spot welding method of joining the workpiece W by the welding system 100 as described above will be described.

First, as illustrated in FIG. 1, the robot control device 62 drives the robot body 60 and the articulated arm 61, thereby controlling the position and posture of the spot welding apparatus 1 such that the workpiece W is arranged between the upper electrode tip 21 and the lower electrode tip 26. At this point, the robot control device 62 controls the position and posture of the spot welding apparatus 1 such that the lower electrode tip 26 contacts a lower surface of the second metal plate W2 of the workpiece W.

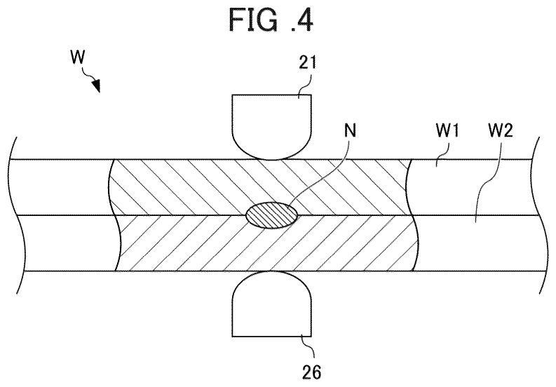

Next, as illustrated in FIG. 4, the upper adaptor body 23 is slid using the upper electrode tip movement mechanism 4 such that the upper electrode tip 21 approaches the lower electrode tip 26. FIG. 4 is a diagram illustrating a state in which the welding current is applied to the workpiece W while the workpiece W is held between and pressurized by the upper electrode tip 21 and the lower electrode tip 26. When the upper electrode tip 21 approaches the lower electrode tip 26 and comes into contact with an upper surface of the first metal plate W1, the workpiece W is held between and pressurized by the upper electrode tip 21 and the lower electrode tip 26.

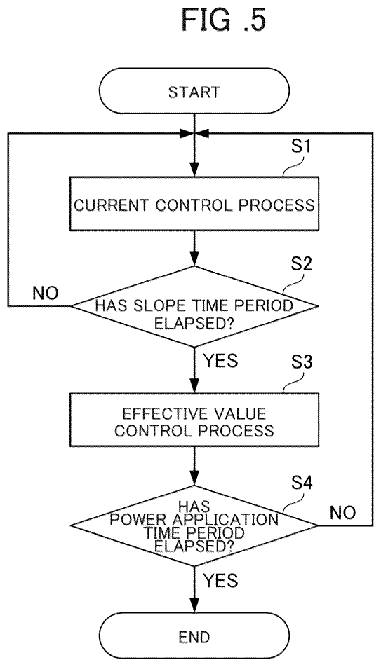

Next, the control device 33 of the welding power source circuit 3 executes the welding current control by the procedure described with reference to FIG. 5 while maintaining a state in which the workpiece W is pressurized from both sides by the upper electrode tip 21 and the lower electrode tip 26, and applies the pulse-shaped welding current to between the upper electrode tip 21 and the lower electrode tip 26. In this manner, as illustrated in FIG. 4, a nugget N is formed between the first metal plate W1 and the second metal plate W2, and the first metal plate W1 and the second metal plate W2 are welded to each other.

### (Procedure of Welding Current Control)

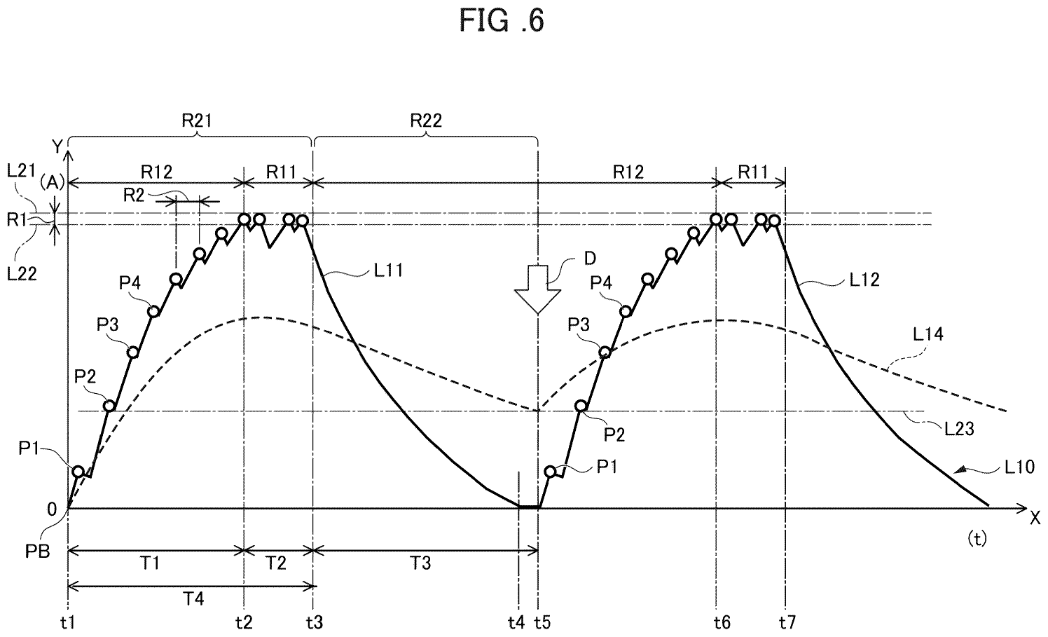

A procedure of the welding current control and the waveform of the welding current will be described with reference to FIGS. 5 and 6. FIG. 5 is a flowchart illustrating a specific procedure of the welding current control in the control device 33. FIG. 6 is a graph showing the waveform of the welding current achieved by the welding current control of FIG. 5.

As described above, in the welding current control, the pulse-shaped welding current is applied. As a relationship between pulse-shaped waveforms adjacent to each other of the welding current, there may be considered a case where the pulse-shaped waveforms do not overlap and a case where the pulse-shaped waveforms overlap. FIG. 6 shows a case where the pulse-shaped waveforms adjacent to each other of the welding current do not overlap.

Prior to the description of the procedure of the welding current control, a graph in FIG. 6 will be described. In the graph, the X-axis indicates the time (t), and the Y-axis indicates the current (A). The X-axis or the current 0 indicates a bottom current PB. The line L10 indicates the welding current, the line L11 indicates the first pulse-shaped waveform in the welding current, and the line L12 indicates the second pulse-shaped waveform in the welding current. The first pulse-shaped waveform L11 is a first wave in the successive pulse wave and the second pulse-shaped waveform L12 is a second wave in the successive pulse wave. A range R2 indicates a PWM pulse.

In the example shown in FIG. 6, the first pulse-shaped waveform L11 and the second pulse-shaped waveform L12 in the welding current L10 do not overlap. After the current value of the first pulse-shaped waveform L11 decreases to 0 V or the bottom current PB, the second pulse-shaped waveform L12 rises. A time point when the current value of the first pulse-shaped waveform L11 decreases to 0 V is shown as a time point t4, and a time point when the second pulse-shaped waveform L12 starts to rise is shown as a time point t5. In the example illustrated in FIG. 6, the time point t5 is a time point after the time point t4.

### (Peak State and Non-Peak State)

As shown in FIG. 6, the welding current generated by a current control process of FIG. 5 has a pulse-shaped waveform that alternates between a peak state in which the welding current reaches or is maintained within a set peak current range R1 and a non-peak state which is a state until the welding current starts to increase toward the peak current range R1 again after having decreased toward a bottom current PB (e.g., 0 V) from the peak current range R1. In FIG. 6, the range of the peak state is shown as a range R11, and the range of the non-peak state is shown as a range R12. Note that the peak current range R1 is a range in which the welding current is a predetermined lower limit value L22 or more and a predetermined upper limit value L21 or less.

### (Effective Value of Welding Current)

In FIG. 6, a line L14 indicates an effective value of the welding current. The control device 33 can acquire a present current value Ipv as a present welding current value using the current detection signal transmitted from the current sensor 3d. The control device 33 calculates an effective value Irms of the welding current using the present current value Ipv. Specifically, the control device 33 calculates the root-mean-square of the present current value Ipv over a time period elapsed from the start of the welding current control to a present point of time, so that the effective value Irms can be calculated.

### (Target Rise Current Value)

In the control device 33, a target rise current value Isp as a target current value of the welding current is set in advance. In FIG. 6 and the like, some of the target rise current values Isp are indicated by points P1 to P4, and the like. A plurality of target rise current values Isp are set between current rising slopes and in the peak current range R1.

The point P1 shown in FIG. 6 is a target rise current value Isp set for a first pulse. The point P2 is a target rise current value Isp set for a second pulse. Hereinafter, the same applies to the points P3 and P4. The target rise current value Isp indicated by the point P1 is referred to as a first target rise current value P1. The same applies to the other target rise current values Isp.

The procedures of the current control process and effective value control process included in the welding current control will be described with reference to FIG. 5. In FIG. 6, a period in which the current control process is performed is indicated by a range R21, and a period in which the effective value control process is performed is indicated by a range R22. In the following description and drawings, S1 represents step 1. The same applies to S2 and thereafter.

### (S1)

S1 is a step in which the control device 33 executes the current control process. The current control process is a process in which the control device 33 increases the welding current from the bottom current PB toward the peak current range R1, and then maintains the peak state R11 for a predetermined time period.

### (S2)

S2 is a step in which the control device 33 determines whether a predetermined slope time period T4 has elapsed. If the determination result in S2 is NO, the control device 33 returns to S1 to continuously execute the current control process, and if the determination result in S2 is YES, the control device 33 proceeds to S3.

Note that the slope time period T4 is a time period obtained by adding up a current rise time period T1 and a peak holding time period T2, and is set in advance. The current rise time period T1 is a time period until the welding current reaches the upper limit value L21 of the peak current range R1 from the bottom current PB, that is, a time period from the time point t1 to the time point t2. The peak holding time period T2 is a time period for which the welding current is maintained within the peak current range R1, that is, a time period from the time point t2 to the time point t3. The slope time period T4 is a time period from the time point t1 to the time point t3.

### (S3)

S3 is a step in which the control device 33 executes the effective value control process. The effective value control process is a process in which the control device 33 waits for execution of the current control process R21 over a standby time period determined on the basis of the effective value of the welding current. The standby time period determined on the basis of the effective value of the welding current is a time period corresponding to a power application standby time period T3 shown in FIG. 6. The power application standby time period T3 is a time period from the time point t3 when the peak holding time period T2 ends to the time point t5 when the second pulse-shaped waveform L12 starts to rise.

### (S4)

S4 is a step in which the control device 33 determines whether the set power application time period has elapsed since the start of the welding current control. The power application time period corresponds to a time period taken to join a single spot of the workpiece W by the spot welding apparatus 1, and is set in advance. If the determination result in S4 is NO, the control device 33 returns to S1 to execute the current control process again. If the determination result in S4 is YES, the control device 33 ends the process of FIG. 5 to start joining of a next spot of the workpiece W.

As described above, in the welding current control, the control device 33 repeatedly executes the current control process (see S1) and the effective value control process (see S3) over the power application time period, thereby applying the welding current with the pulse-shaped waveform as shown in FIG. 6 to between the upper electrode tip 21 and the lower electrode tip 26.

(Case where First Pulse-Shaped Waveform and Second Pulse-Shaped Waveform Overlap)

A summary of the procedure of the current control process and a summary of the waveform of the welding current have been described above with reference to FIG. 6 and the like showing the example in which the first pulse-shaped waveform L11 and the second pulse-shaped waveform L12 of the welding current do not overlap. Here, when the effective value of the welding current increases, a next pulse-shaped waveform may rise while the pulse-shaped waveform of the welding current is falling. In this case, overlap of the pulse-shaped waveforms occurs. A case where the pulse-shaped waveforms overlap will be described below with reference to the drawings.

### (Set Welding Current)

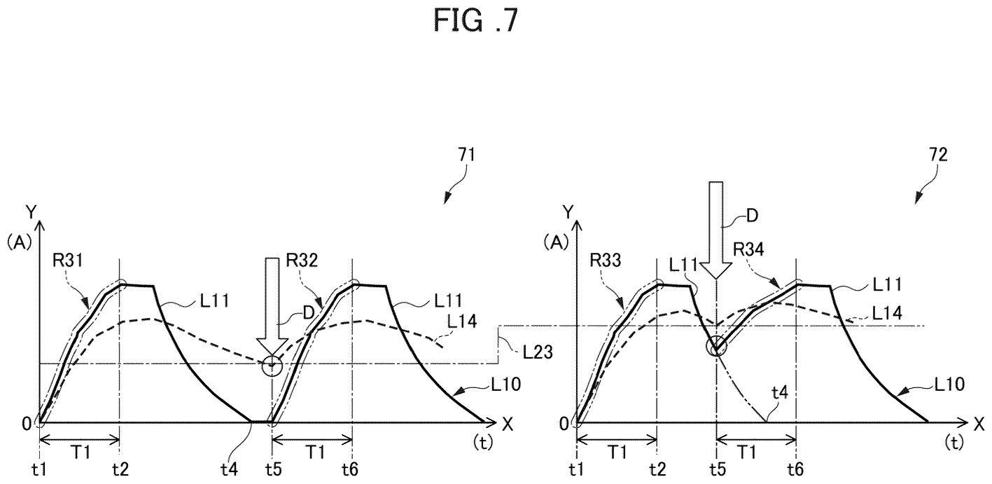

FIG. 7 is a graph showing a change tendency of the welding current when a set welding current is changed. The set welding current is a reference current value for starting the current control of increasing the welding current toward the peak current range. In a case where the effective value of the welding current decreases to the set welding current, the current control of increasing the welding current toward the peak current range is started.

A graph 71 on the left side of FIG. 7 shows a case where the pulse-shaped waveforms do not overlap. A graph 72 on the right side of FIG. 7 shows a case where the pulse-shaped waveforms overlap. In FIG. 7 and the like, the line L14 indicates an effective value of the welding current, and a line L23 indicates a set welding current. An arrow D indicates a time point when a next chopping waveform starts.

In the spot welding method of the present embodiment, in a case where the pulse-shaped waveform is in the non-peak state, the current control of increasing the welding current toward the peak current range is started in a case where the effective value of the welding current reaches a value within the set target range. A time point when the effective value of the welding current reaches a value within the set target range is a time point t5 or a time point when the second pulse-shaped waveform L12 starts to rise. The set welding current L23 is an upper limit value of the above-described target range. A range of the set welding current L23 or less becomes the above-described target range.

The time point t5 is a time point when the effective value L14 corresponding to the first pulse-shaped waveform L11 decreases to the set welding current L23. From the time point t5, the welding current control of increasing the welding current toward the peak current range is started. The welding current in the graph 71 on the left side of FIG. 7 is the same as the welding current shown in FIG. 6. In the example shown in the graph 71 on the left side, the time point t5 is later than the time point t4 when the current value of the first pulse-shaped waveform L11 decreases to 0. Therefore, the second pulse-shaped waveform L12 does not overlap with the first pulse-shaped waveform L11. The second pulse-shaped waveform L12 rises from the bottom current PB toward the peak current range at the time point t5.

The welding current control shown in the graph 72 on the right side of FIG. 7 will be described. In the example shown in the graph 72 on the right side, the set welding current L23 is set to a current value higher than that in the example in the graph 71 on the left side. Therefore, the time point t5 when the effective value of the welding current reaches a value within the set target range is before the time point t4 when the current value of the first pulse-shaped waveform L11 is expected to decrease to 0 V. Therefore, the first pulse-shaped waveform L11 and the second pulse-shaped waveform L12 of the welding current overlap. In this way, when a value of the set welding current increases in this manner, the waveforms adjacent to each other may overlap. When the set effective value of the welding current increases, the waveforms adjacent to each other are likely to overlap.

### (Rising Slope of Pulse-Shaped Waveform)

Next, a rising slope of the pulse-shaped waveform will be described. A time period taken until the welding current reaches the peak current range is referred to as a rise time period T1. The welding current is controlled by a rise time period T1 set in advance. Therefore, in a case where overlap of the pulse-shaped waveforms occurs, the rising slope of the second pulse-shaped waveform L12 as the shape of the second wave may be different from the rising slope of the first pulse-shaped waveform L11 as the shape of the first wave.

In FIG. 7, portions corresponding to the rising slope of the pulse-shaped waveform are indicated by ranges R31 to R34. In the graph 71 on the left side, the rising of the first wave indicated in the range R31 and the rising of the second wave indicated in the range R32 have the same rising slope of the waveform.

In contrast, in the graph 72 on the right side, the rising of the first wave indicated in the range R33 and the rising of the second wave indicated in the range R34 have different waveform rising slopes. The rising slope of the first wave indicated in the range R33 is the same as the rising slope of the first wave indicated in the range R31 and the rising slope of the second wave indicated in the range R32 in the graph 71 on the left side. On the other hand, the rising slope of the second wave indicated in the range R34 is different from these rising slopes.

As described above, the welding current is controlled by the rise time period T1. Therefore, in a case where the overlap of the pulse-shaped waveforms occurs, the rising slope of the wave changes between the first wave and the second wave. In the graph 72 on the right side, the current value is not 0 at the time point t5 unlike the graph 71 on the left side. Therefore, in order to increase the welding current to the peak current range in the rise time period T1 in the graph 72 on the right side, it is necessary to make the slope gentler than a case where the welding current is increased to the peak current range in the rise time period T1 in the graph 71 on the left side. This is because in the graph 72 on the right side, the current value to be increased is smaller than that in the graph 71 on the left side.

When the rising slope of the waveform changes, the conditions for heat input to a welding spot change. As a result, the welding quality is degraded.

### (Setting of First Target Current Value)

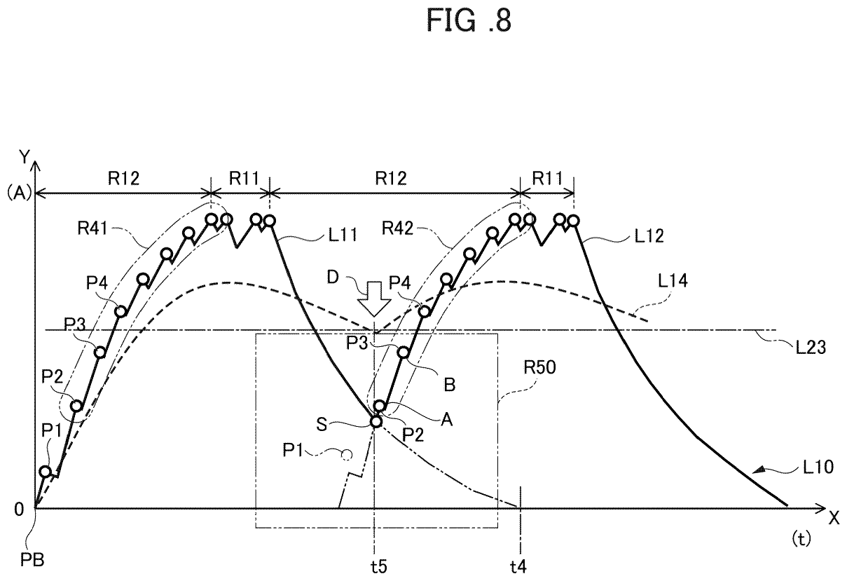

FIG. 8 is a graph showing a waveform of the welding current of the present embodiment. In FIG. 8, like the graph 72 on the right side of FIG. 7, the time point t5 when the effective value L14 of the welding current reaches a value within the set target range or the set welding current L23 is before the time point t4 when the current value of the first pulse-shaped waveform L11 is expected to decrease to 0 V.

In the spot welding method of the present embodiment, in the welding current, the target rise current value is set for each predetermined PWM pulse when the welding current increases toward the peak current range. Points P1 to P4 of FIG. 8 are some of the target rise current values. In the spot welding method of the present embodiment, in a case where the effective value of the welding current reaches a value within the set target range while the welding current is decreasing toward the bottom current PB, a target rise current value that is larger than and the closest to a rise start current value (rise start current) is set as a first target current value.

In a case where the effective value L14 of the welding current reaches a value within the set welding current L23 while the welding current L10 is decreasing toward the bottom current PB, the current value of the welding current at that time point is not 0. The current value of the welding current at this time point is referred to as a rise start current value S. Then, the rise start current value S is larger than at least one of the target rise current values set in advance. In this case, a target rise current value that is larger than the rise start current value S and is the closest to the rise start current value S is set as a first target current value.

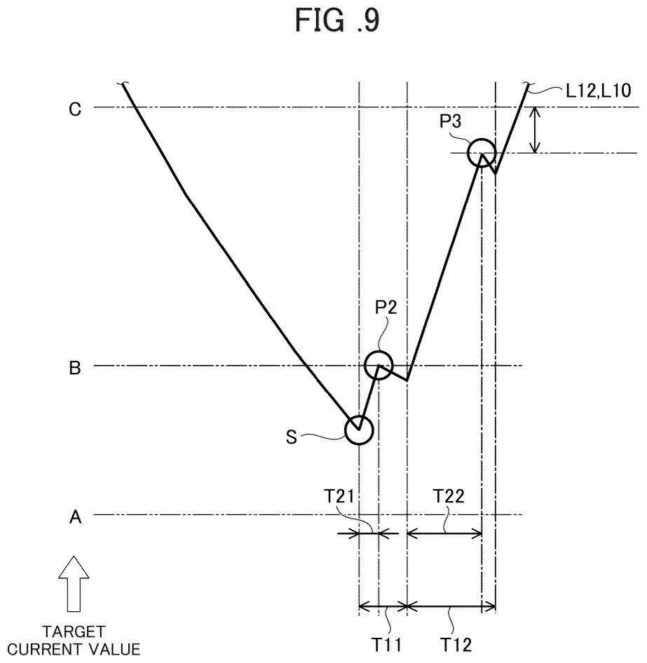

FIG. 9 is a graph showing a frame R50 of FIG. 8 in an enlarged manner. As illustrated in FIG. 9, the rise start current value S is larger than a first target rise current value P1. Then, a second target rise current value P2 as a target rise current value that is larger than the rise start current value S and is the closest to the rise start current value S is set as a first target current value A. The welding current value increases toward the peak current range according to the second target rise current value P2 as the first target current value A and a third target rise current value P3.

A range R41 of FIG. 8 indicates a portion corresponding to the rising slope of the first pulse-shaped waveform L11. A range R42 indicates a portion corresponding to the rising slope of the second pulse-shaped waveform L12. In the spot welding method of the present embodiment, unlike the example shown in the graph 72 on the right side of FIG. 7, the waveform rising slope of the second pulse-shaped waveform L12 indicated in R42 is the same as the waveform rising slope of the first pulse-shaped waveform L11 indicated in R41. This is because the waveform of the second pulse-shaped waveform L12 also rises according to the target rise current value set in advance, like the waveform of the first pulse-shaped waveform L11.

In the spot welding method of the present embodiment, in a case where the effective value of the welding current reaches a value within the set target range while the welding current is decreasing toward the bottom current PB, a target rise current value that is larger than and the closest to a rise start current value is set as a first target current value. This makes it possible to maintain a constant rising slope of the welding current even in a case where the welding current is increased toward the peak current range while the welding current is decreasing toward the bottom current. That is, this makes it possible to perform the current control by which the waveform rising slope is kept constant even when the pulse-shaped waveforms overlap. As a result, a heat input quantity can be stabilized, making is possible to reduce the degradation in welding quality.

### (Process Flow)

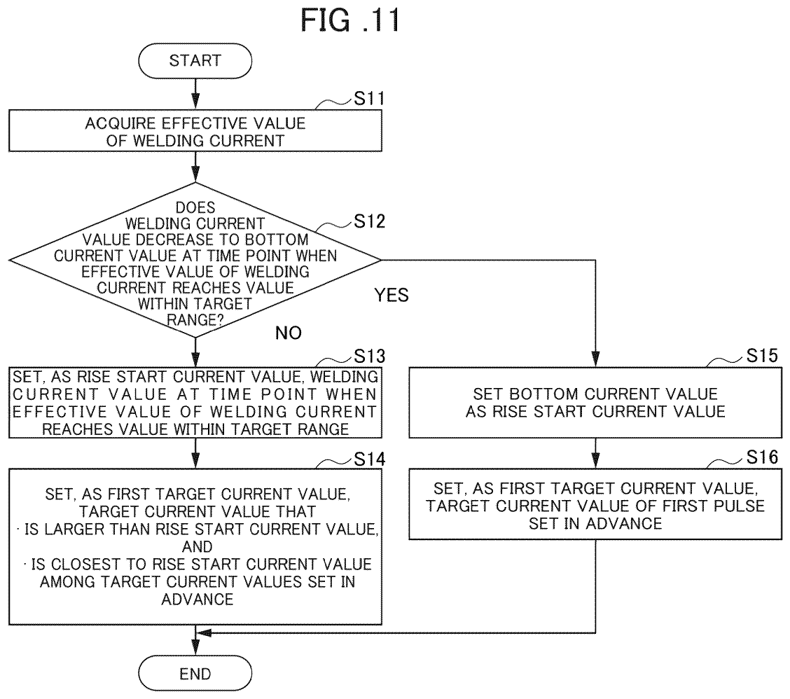

A process flow of the spot welding method of the present embodiment will be described with reference to FIG. 11. FIG. 11 is a flowchart illustrating a process flow of the spot welding method of the present embodiment.

### (S11)

S11 is a step of acquiring an effective value of the welding current. For example, the control device can acquire a present current value on the basis of the current detection signal from the current sensor, and calculate an effective value of the welding current using the acquired present current value.

### (S12)

S12 is a step of determining whether the welding current decreases to the current value of the bottom current at the time point when the effective value of the welding current has reached a value within the target range. The control device determines whether the value of the welding current is the current value of the bottom value at the time point when the effective value of the welding current acquired in S11 reaches the set welding current set in advance. If the determination result is YES, the first pulse-shaped waveform and the second pulse-shaped waveform do not overlap. If the determination result is YES, the step proceeds to S15. If the determination result is NO, the first pulse-shaped waveform and the second pulse-shaped waveform overlap. If the determination result is NO, the step proceeds to S13.

### (S13)

S13 is a step of setting, to the rise start current value, a welding current value at the time point when the effective value of the welding current reaches a value within the target range. The second pulse-shaped waveform starts to rise from this rise start current value toward the peak current range.

### (S14)

S14 is a step of setting, to the first target current value, a target rise current value that is larger than the rise start current value among the target rise current values set in advance and is the closest to the rise start current value among the target rise current values set in advance. The first pulse target rise current value in the target rise current values set in advance is not set to a first target current value in the second pulse-shaped waveform, but a target rise current value that is directly close to the higher side than the rise start current value among the target rise current values set in advance is set to the first target current value. Thus, the rising slope of the second pulse-shaped waveform becomes the same as the rising slope of the first pulse-shaped waveform. After S14, the process ends.

### (S15)

S15 is a step of setting the current value of the bottom current to the rise start current value. If the determination result in S12 is YES, the welding current value decreases to the current value of the bottom current. Therefore, the current value of the bottom current is set to the rise start current value of the second pulse-shaped waveform.

### (S16)

S16 is a step of setting, to the first target current value, the first pulse target rise current value set in advance, or a first pulse target current value. When the first pulse-shaped waveform and the second pulse-shaped waveform do not overlap, the welding current is increased toward the peak current range using the target rise current values set in advance in the same manner as the first pulse-shaped waveform. After S16, the process ends.

### Second Embodiment

A spot welding method of a second embodiment of the present invention will be described. In the second embodiment, items which differ from the first embodiment will be mainly described. The items not particularly described in the second embodiment can be the same as those of the first embodiment. The second embodiment is different from the first embodiment in how to set the target current value. In the first embodiment, a new target current value is set using only the target rise current values set in advance. In the second embodiment, a new current value is created, and a target current value is set using target rise current values set in advance and the newly created current value. This makes it possible to reduce a rapid change in the pulse width.

### (Fluctuation in Pulse Width)

The fluctuation in pulse width will be described. In the spot welding method of the present embodiment, as the target current values, a target rise current value next largest to the first target current value B is set as a second target current value C, and an intermediate target current value is set between the first target current value and the second target current value. As shown in FIG. 9, since the first target current value A is smaller than the rise start current value S, the second target current value B is set to a second target rise current value P2. A third target current value C that is a target current value next to the second target current value B can be also set to a third target rise current value P3 that is a target rise current value next to the second target rise current value P2. However, in this case, the pulse width may rapidly change. The description will be given below.

A time period T21 of FIG. 9 is a pulse width from the rise start current value S to the first target current value B (second target rise current value P2). Each of the time periods T11 and T12 is a PWM pulse cycle. As shown in FIG. 9, in a case where the target rise current values set in advance are set in order of the first target current value B and the second target current value C, the pulse width may rapidly change. That is, a difference between the time period T21 and the time period T22 may increase. Furthermore, there may be a case where the current value cannot reach the second target current value C.

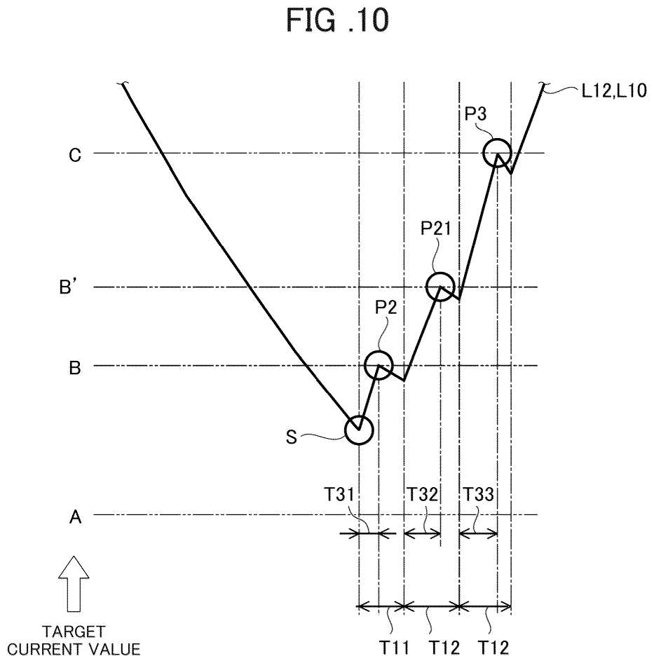

Then, in the spot welding method of the present embodiment, a target rise current value next largest to the first target current value B is set as the second target current value C, and an intermediate target current value B′ is set between the first target current value B and the second target current value C. In FIG. 10, the intermediate target current value B′ is indicated by a point P21. The point P21 as the intermediate target current value B′ is located between the second target rise current value B and the third target rise current value C.

The intermediate target current value B′ is set, which makes it possible to reduce a rapid change in pulse width. In FIG. 10, a time period T31 is a pulse width from the rise start current value S to the first target current value B (second target rise current value P2). A time period T32 is a pulse width from the first target current value B (second target rise current value P2) to the intermediate target current value B′ (point P21). A time period T33 is a pulse width from the intermediate target current value B′ (point P21) to the second target current value C (third target rise current value P3). As shown in FIGS. 9 and 10, each of a difference between the time period T31 and the time period T32 and a difference between the time period T32 and the time period T33 is smaller than a difference between the time period T21 and the time period T22. In FIG. 9, the current value does not reach the second target current value C (point P3), but in FIG. 10, P3 can reach the second target current value C. The intermediate target current value B′ is set in this manner, which makes it possible reduce a rapid change in pulse width and improve the reach performance to the target current.

### (Calculation of Intermediate Target Current Value)

The intermediate target current value A′ can be calculated by the following calculation equation:

$${A}^{′} = A + coefficient \times ( B - A ) ;$$

where,
A: first target current value,
A′: intermediate target current value,
B: second target current value, and
coefficient: any value of more than 0% and less than 100%.

The value of the coefficient is adjusted by the above-described calculation equation, so that a rapid change in the pulse width can be further reduced.

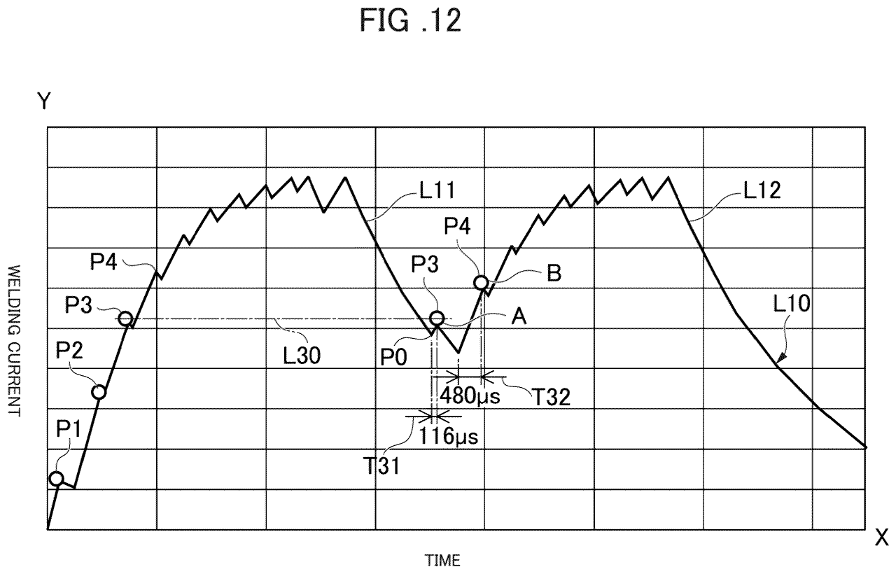

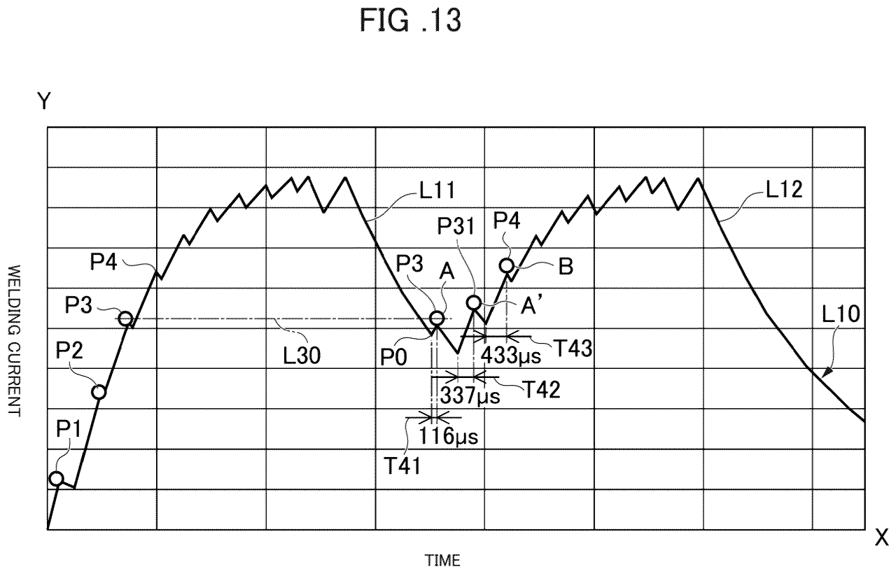

A difference in pulse width between the presence and absence of setting of the intermediate target current value will be described with reference to FIGS. 12 and 13. FIG. 12 is a graph showing the welding current in a case where the intermediate target current is not set. FIG. 13 is a graph showing the welding current in a case where the intermediate target current is set. In the example shown in FIG. 13, the coefficient in the above-described calculation equation when the intermediate target current value is calculated is 30%. In the graph shown in each of FIGS. 12 and 13, the X-axis indicates the time (ms), and the Y-axis indicates the welding current (A)

In the example shown in each of FIGS. 12 and 13, the rise start current value S is located between the second target rise current value P2 as one of the target rise current values set in advance and the third target rise current value P3 as one of the target rise current values set in advance. That is, FIGS. 12 and 13 each shows a case where the second wave is restarted in the vicinity of the third target rise current value P3.

The first target current value A is set to the third target rise current value P3, and the second target current value B is set to the fourth target rise current value P4.

Also in the examples of FIGS. 12 and 13, the first target current value A is 10251 A as the third pulse target current vale P3, and the second target current value B is 12807 A as the fourth pulse target current vale P4.

(Case where Target Current Value is not Set)

First, a case where the target current value A′ is not set will be described with reference to FIG. 12. In the graph shown in FIG. 12, a time period T31 is a pulse width from the rise start current value S to the first target current value A. A time period T32 is a pulse width from the first target current value A to the second target current value B. The pulse width has increased from 116 μs in the time period T31 to 480 μs in the time period T32 by 364 μs.

As for the current value, the current value that has reached the first target current value A is 10264 A, and a difference from 10251 A as the target current value is 13 A. The current value that has reached the second target current value B is 11944 A, and a difference from 12807 A as the target current value is 863 A. That is, in a case where the intermediate target current value A′ is not set, the maximum difference between the target current value and the current value that has reached the second target current value B is 863 A in a period until the current value reaches the second target current value B.

(Case where Target Current Value is Set)

Next, a case where the intermediate target current value A′ is set will be described with reference to FIG. 13. In FIG. 13, the intermediate target current value A′ is indicated by a point P31. The first target current value A and the second target current value B are the same as in the example shown in FIG. 12. The intermediate target current value A′ is set at 11018 A. The value 11018 A is a value calculated using the coefficient 30% in the above-described calculation equation for the intermediate target current value A.

In the graph shown in FIG. 13, a time period T41 is a pulse width from the rise start current value S to the first target current value A. A time period T42 is a pulse width from the first target current value A to the intermediate target current value A′. A time period T43 is a pulse width from the intermediate target current value A′ to the second target current value B. The pulse width increases from 116 μs in the time period T41 to 337 μs in the time period T42 by 221 μs. Furthermore, the subsequent pulse width increases from 337 μs in the time period T42 to 433 μs in the time period T43 by 96 μs. Each of the increasing amounts of 221 μs and 96 μs is smaller than 364 μs as the increasing amount in a case where the intermediate target current value A′ is not set. The intermediate target current value A′ is set in this manner, which makes it possible reduce a difference between the first pulse width and the second pulse width from 364 μs to 221 μs by about 60%.

As for the current value, the current value that has reached the first target current value A is 10264 A, and a difference from 10251 A as the target current value is 13 A. The current value that has reached the intermediate target current value A′ is 11022 A, and a difference from 11018 A as the target current value is 4 A. The current value that has reached the second target current value B is 12814 A, and a difference from 12807 A as the target current value is 7 A. In a case where the intermediate target current value A′ is set, the maximum difference between the target current value and the current value that has reached the second target current value B is 13 A in a period until the current value reaches the second target current value B. The intermediate target current value A′ is set in this manner, so that the maximum difference between the target current value and the current value that has reached the second target current value B is improved from 863 A to 13 A by about 66 times in a period until the current value reaches the second target current value B.

It has been confirmed that the maximum difference between the target current value and the current value that has reached the second target current value B is improved by setting the intermediate target current value A′ even for all pulses until the welding current reaches the peak current range.

In a case where a next pulse waveform rises while the pulse-shaped waveform is falling, that is, in a case where the pulse-shaped waveforms overlap, a fluctuation in pulse width immediately after the rising increases, which may cause sharp rising. In such a case, bias magnetism of a welding transformer may be caused. In the spot welding method of the present embodiment, the intermediate target current value is set between the first target current value and the second target current value, which makes it possible to reduce a rapid fluctuation in pulse width.

### (Reduction of Control Load)

The control device 33 performs various arithmetic operations such as an arithmetic operation for generating a gate drive signal to transmit the generated gate drive signal to the inverter circuit 32. The spot welding method of each embodiment described above makes it possible not to include, in arithmetic operations in control of the effective value, the target rise current value that is lower than a rise start current value that is a current value when the current control of increasing the welding current is started. The description will be given with reference to FIG. 8.

As shown in FIG. 8, in a case where the first pulse-shaped waveform L11 and the second pulse-shaped waveform L12 overlap, the target rise current value having a current value lower than the rise start current value S among the target rise current values set in advance is not used for the control of the second wave rising. In the example shown in FIG. 8, the first pulse target current value P1 is not used for the control of the second wave rising. The first pulse target current value P1 is not included in objects of the arithmetic operations of the control device 33.

Thus, the target rise current value lower than the rise start current value S is removed from the objects of the arithmetic operations, which makes it possible to reduce the control load.

As described above, in the spot welding method of one aspect of the present invention, the target value of the rising current is set for each PWM pulse. In a case where a chopping waveform is applied and a next chopping waveform is started while the chopping waveform is falling, the target value that is larger than and the closest to a current at which the chopping is started is set as a first target value (A). Next, a target value (A′) is added to between the above-described target value and a next target value (B). The added target value A′ is obtained from A′=A+coefficient×(B−A). The coefficient is any value of more than 0% and less than 100%. This makes it possible to achieve a control method by which the rising slope of the welding current is not changed and a rapid change in PWM pulse is reduced even in a case where pulse-shaped waveforms overlap.

Embodiments of the present invention have been described above, but the present invention is not limited thereto. Detailed configurations may be changed as necessary within the scope of the gist of the present invention.

### EXPLANATION OF REFERENCE NUMERALS

L10 welding current
L11 first pulse-shaped waveform
L12 second pulse-shaped waveform
L14 effective value of welding current
L23 set welding current (target range)
P target rise current value
R1 peak current range
R11 peak state
R12 non-peak state
PB bottom current
S rise start current value
A first target current value
B second target current value
A′ intermediate target current value

What is claimed is:

1. A spot welding method in which a welding current is controlled by PWM control,
the welding current having a pulse-shaped waveform that alternates between a peak state in which the welding current reaches or is maintained within a set peak current range and a non-peak state in which the welding current increases toward the peak current range again after having decreased from the peak current range toward a bottom current,
the spot welding method comprising:
staring, in the non-peak state, current control of increasing the welding current toward the peak current range to thereby join a workpiece in a case where an effective value of the welding current reaches a value within a set target range;
setting a target rise current value for each predetermined PWM pulse when the welding current increases toward the peak current range; and
setting, as a first target current value, the target rise current value that is larger than and the closest to a rise start current value in a case where the effective value of the welding current reaches a value within the set target range while the welding current is decreasing toward the bottom current.

2. The spot welding method according to claim 1, further comprising, for the target rise current value:
setting a target value next largest to the first target current value as a second target current value; and
setting an intermediate target current value between the first target current value and the second target current value.

3. The spot welding method according to claim 1, further comprising:
controlling the effective value of the welding current such that
the target rise current value that is lower than a rise start current value at the starting the current control of increasing the welding current is not included in an arithmetic operation.

4. The spot welding method according to claim 2, wherein the intermediate target current value is calculated by the following calculation equation:
$${A}^{′} = A + coefficient \times ( B - A ) ;$$
where A is the first target current value, A′ is the intermediate target current value, B is the second target current value, and
the coefficient is any value of 0% or more and 100% or less.
